(19) United States
(12) Patent Application Publication
(10) Pub. No.: US 2017/0192854 A1
(43) Pub. Date: Jul. 6, 2017

(54) EMAIL RECOVERY VIA EMULATION AND INDEXING

(71) Applicant: Dell Software, Inc., Round Rock, TX (US)

(72) Inventors: Sergey Romanovich Vartanov, St. Petersburg (RU); Alexander Gennadievich Stepanoff, Kolpino (RU); Sergey Evgenievich Zalyadeev, St. Petersburg (RU)

(21) Appl. No.: 14/989,654

(22) Filed: Jan. 6, 2016

(51) Int. Cl. G06F 11/14; H04L 12/58

(52) U.S. Cl. CPC G06F 11/1451; G06F 11/1469; H04L 51/046; G06F 2201/80

(57) ABSTRACT

Emails can be recovered in a quick and granular fashion by restoring an EDB within an emulated Exchange server environment and then creating a full-text index for each mailbox in the restored EDB. The full-text index could then be employed to perform searches for particular emails thereby leveraging the granular search capabilities that the full-text index provides. Any emails that are identified by searching the full-text index can then be retrieved from the restored EDB in the emulated Exchange environment and populated into the production Exchange environment. In this way, a user can restore specific emails to the production environment in a quick and efficient manner.

### CROSS-REFERENCE TO RELATED APPLICATIONS

N/A

### BACKGROUND

Currently, there are a number of solutions for backing up and recovering a Microsoft Exchange database (EDB). For example, Veritas (formerly Symantec) NetBackup and EMC Data Protection Suite, among many others, offer tools for creating backups of an EDB and restoring an Exchange server from such backups. Each of these solutions creates a backup using a proprietary process and storage format. Therefore, the same solution that was used to create the backup generally must be used to restore from the backup. Typically, the process of restoring a backup requires identifying the Exchange server as the destination for the restore, and then the solution will recreate the EDB within the identified Exchange server environment.

These backup solutions are effective when it is desired to restore the entire EDB. For example, if a company's Exchange server were damaged, a backup solution could be employed to restore the entire Exchange server to a previous state. In contrast, in some cases, it may only be desirable to restore a portion of the EDB. For example, a particular user may desire to restore a few emails that were accidently deleted or otherwise lost. Currently, there would be limited, if any, options for restoring the emails at such a granular level without restoring the entire EDB that contained the emails.

Additionally, even after an EDB is restored, there are limited capabilities for searching for content within the EDB. The EDB generally comprises an .edb file and corresponding log files. The .edb file is the main repository for the email data and employs a B+ tree structure to store this data. Microsoft provides an Extensible Storage Engine (ESE) that is configured to maintain and update the EDB. Generally speaking, ESE is positioned between Exchange and the EDB and accepts requests from Exchange (via an API) to update the EDB (e.g., to update the EDB to include a new email).

Due to the format of an EDB (which is a type of indexed sequential access method (ISAM) file), it is not possible to access an EDB using complex SQL queries. Instead, the ESE provides an API through which clients (e.g., Exchange) can access the records of the EDB in a sequential manner Although the details of employing the ESE API to access an EDB are beyond the scope of the present discussion, the following simplified overview will be provided to give context for why it is difficult to search an EDB for relevant email data.

An EDB is stored as a single file and consists of one or more tables. Data is organized in records (or rows) in the table with one or more columns. One or more indexes are also defined which identify different organizations (or orderings) of the records in the table. Using the ESE API, a client (e.g., Exchange), can create a cursor that navigates the records in the database in accordance with the ordering defined by a particular index. In other words, the ESE API allows the client to position the cursor at a particular record in a table and to commence reading records sequentially beginning at that particular record.

Because the ESE API is limited to this type of sequential access (or enumeration) of records, it can be very time consuming to search an EDB for relevant email data. Referring again to the example above, if a particular user desired to locate a few emails that were lost from the current version of the EDB, it would require restoring a backup of the EDB to the Exchange server and then accessing the EDB to sequentially read every email in the user's mailbox to determine whether the email matches a specified query.

### BRIEF SUMMARY

The present invention extends to methods, systems, and computer program products for allowing emails to be recovered in a quick and granular fashion by restoring an EDB within an emulated Exchange server environment and then creating a full-text index for each mailbox in the restored EDB. The full-text index could then be employed to perform searches for particular emails thereby leveraging the granular search capabilities that the full-text index provides. Any emails that are identified by searching the full-text index can then be retrieved from the restored EDB in the emulated Exchange environment and populated into the production Exchange environment. In this way, a user can restore specific emails to the production environment in a quick and efficient manner.

To create full-text indexes, each email in a mailbox stored in the restored EDB can be retrieved and processed to convert the email from its native format into textual name/value pairs which can then be submitted for indexing. This use of name/value pairs to index each email enables the emails across all mailboxes to be efficiently queried using any possible combination of values. The name/value pairs can include a unique identifier of the email which can be used to retrieve the email from the restored EDB once it is determined that the email should be restored to the production environment.

In one embodiment, the present invention is implemented as a method for restoring emails. An emulated Exchange environment can be created that emulates a production Exchange environment. An EDB can then be restored to the emulated Exchange environment from a backup that was created from an EDB in the production Exchange environment. A full-text index can be created for each of a number of mailboxes in the EDB that was restored to the emulated Exchange environment. A particular email can be retrieved from the EDB that was restored to the emulated Exchange environment. The particular email can then be restored to the production Exchange environment.

In another embodiment, the present invention is implemented as a recovery manager for restoring emails. The recovery manager can include an emulated Exchange environment that emulates a production Exchange environment and that is configured to interface with a data protection server to cause a backup of the production Exchange environment to be restored into the emulated Exchange environment, the backup including an EDB. The recovery manager can also include an indexing component configured to generate full-text indexes for mailboxes contained within the EDB once the EDB is restored into the emulated Exchange environment. The recovery manager can further include a recovery console configured to query the full-text indexes to identify particular emails, to obtain the particular emails from the EDB in the emulated Exchange environment, and to restore the particular emails obtained from the EDB in the emulated Exchange environment into an EDB in the production Exchange environment.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which the present invention can be implemented;

FIG. 2 illustrates how an EDB of a production Exchange environment can be backed up and then restored into an emulated Exchange environment;

FIG. 3 illustrates components of an indexing component that can be employed to create a full-text index of a mailbox of an EDB;

FIG. 4 illustrates how an email can be retrieved from a mailbox and converted from its native format into a text-based format suitable for inclusion in a request to index the email;

FIG. 5 illustrates a more detailed example of how the present invention can convert an email from its native format into an HTTP request that includes the content of the email structured as name/value pairs;

FIG. 6 illustrates an example of how the text-based indexes can be queried;

FIGS. 7A and 7B illustrate how an individual email can be restored; and

FIG. 8 illustrates a flowchart of an example method for restoring emails.

### DETAILED DESCRIPTION

In this specification and the claims, the term Exchange Database (or EDB) should be construed as a database that stores email data in accordance with an indexed sequential access method (ISAM). Therefore, although an EDB is a Microsoft-specific database, the term EDB as used herein should be construed to encompass other similarly structured and accessed ISAM-based databases that may not be Microsoft-specific. In other words, the present invention should not be limited to creating full-text indexes from Microsoft Exchange Databases.

The term “production Exchange environment” and its variants refer to the Exchange server and accompanying components (e.g., Active Directory) that are actively employed to provide email services to users. In contrast, the term “emulated Exchange environment” and its variants refer to an Exchange server and accompanying components that are employed for the purpose of temporarily restoring an EDB for the purpose of creating full-text indexes of the mailboxes of the restored EDB. The primary role of the emulated Exchange environment is to allow an EDB to be restored without affecting the production Exchange environment. Therefore, the emulated Exchange environment can be configured to emulate the production Exchange environment so that a backup of an EDB from the production Exchange environment can be restored to the emulated Exchange environment.

The term “data protection server” should be construed as any data protection service and/or appliance (i.e., backup solution) that creates backups of an EDB and that allows the backups to be restored to an Exchange environment (whether production, emulated, or otherwise). For purposes of this disclosure, what should be understood is that the backup solution accesses an Exchange environment to create backups of an EDB in some proprietary format (i.e., the backup solution does not simply store a direct copy of the EDB), and can then be employed to restore the EDB within the Exchange environment from the backup(s).

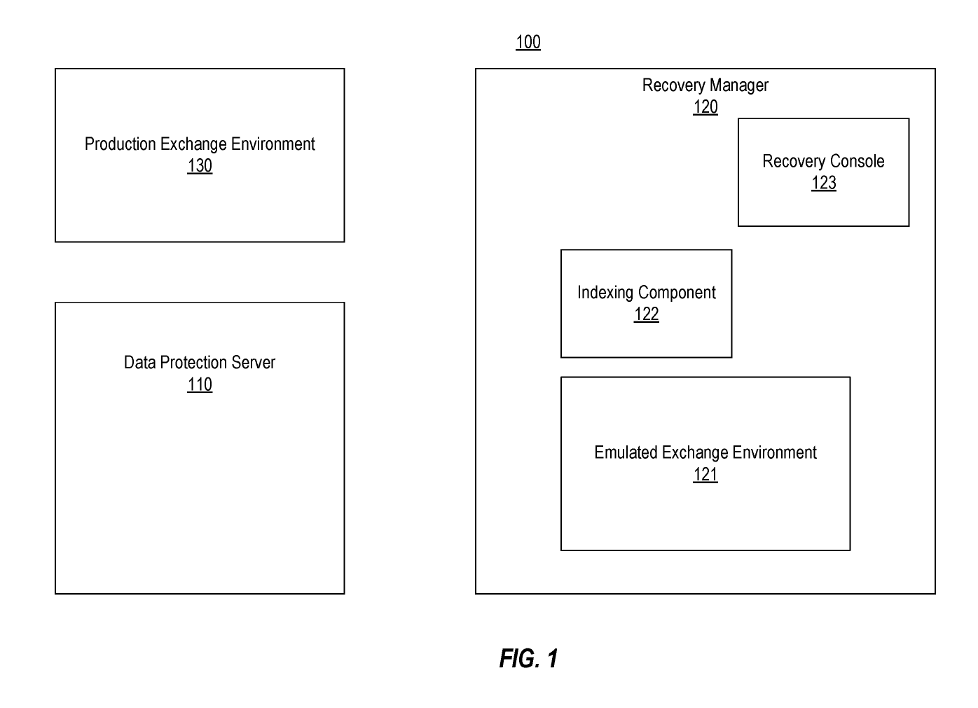

FIG. 1 illustrates an example computing environment 100 in which the present invention can be implemented. Computing environment 100 includes a data protection server 110 that is configured to access production exchange environment 130 for the purpose of creating backups of the environment. Production exchange environment 130 would typically be hosted on a separate server or servers from data protection server 110. However, how production exchange environment 130 is hosted is not essential to the invention. Accordingly, the depiction of data protection server 110 and production exchange environment 130 in FIG. 1 can represent any implementation of an Exchange environment which employs a data protection server to backup the Exchange database.

In accordance with embodiments of the present invention, computing environment 100 also includes recovery manager 120 which includes an emulated Exchange environment 121, an indexing component 122, and a recovery console 123. As mentioned above, emulated Exchange environment 121 can emulate production Exchange environment 130 so that backups of production Exchange environment 130 can be restored into emulated Exchange environment 121 rather than into production Exchange environment 130. The role of indexing component 122 and recovery console 123 will be further described below.

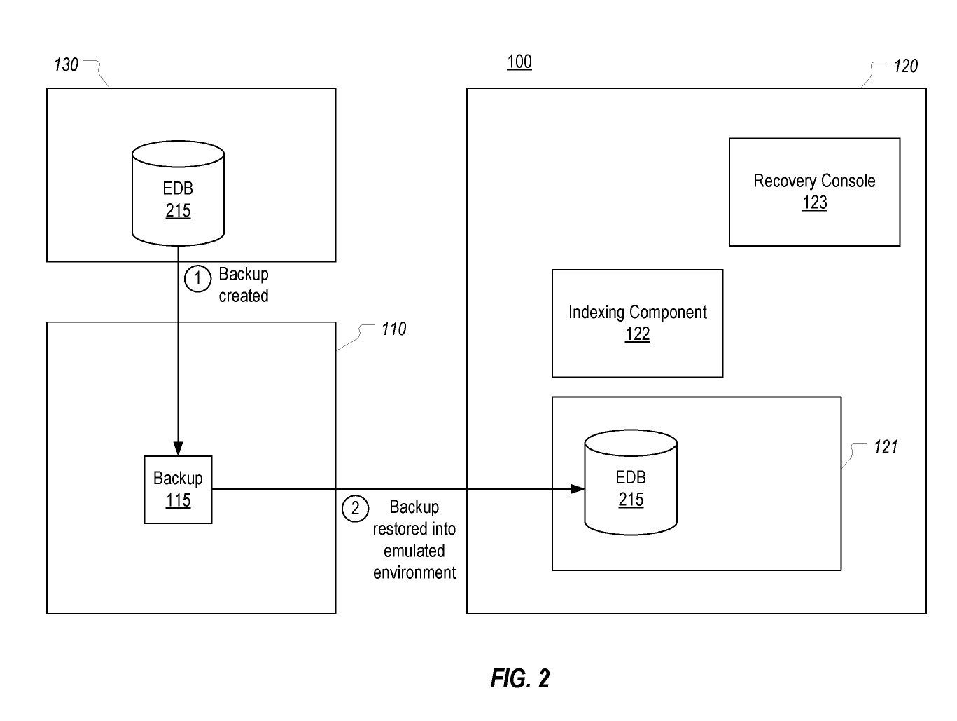

FIG. 2 illustrates the process of restoring a backup into emulated Exchange environment 121 rather than into production Exchange environment 130. As shown, production Exchange environment 130 includes an EDB 215. In a first step, data protection server 110 accesses production Exchange environment 130 to create a backup 115 of EDB 215 (among possibly other content). As described in the Background, data protection server 110 will typically store backup 115 in a proprietary format that requires restoration into an Exchange environment before the content of EDB 215 can again be accessed.

After backup 115 has been created, in a second step, recovery manager 120 can be configured to cause backup 115 to be restored into emulated Exchange environment 121. For example, recovery manager 120 can employ whatever interfaces data protection server 110 provides for restoring a backup. As an example, recovery manager 120 can specify emulated Exchange environment 121 as the destination of the restore. As a result, data protection server 110 will restore backup 115 into emulated Exchange environment 121 thereby restoring EDB 215 within emulated Exchange environment 121.

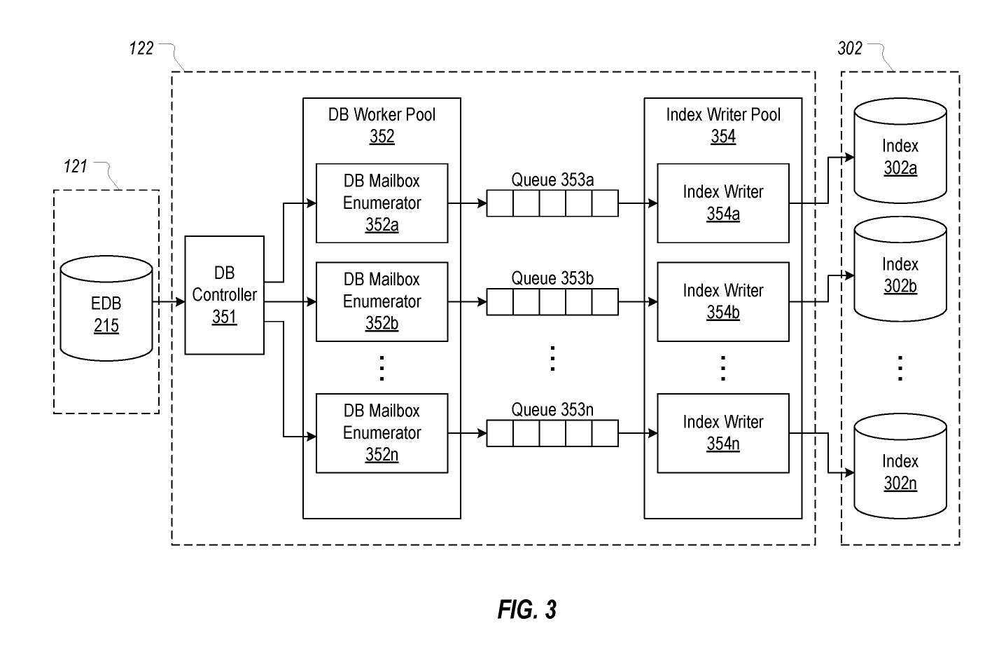

At this point, EDB 215 can be accessed within emulated Exchange environment 121 in much the same way as it could be accessed if restored into production Exchange environment 130. With EDB 215 restored into emulated Exchange environment 121, the conversion of the mailboxes within EDB 215 into full-text indexes can be performed. Indexing component 122 can be employed to perform this conversion as represented in FIG. 3.

To alleviate many of the challenges of searching an EDB as addressed above in the background, the present invention can provide indexing component 122 for converting individual mailboxes stored in EDB 215 into full-text indexes 302a-302n that can then be quickly and efficiently searched using many different types of SQL queries. In FIG. 3, indexing component 122 is generally shown as including a DB controller 351, a DB worker pool 352 that includes a number of DB mailbox enumerators 352a-352n, a corresponding number of queues 353a-353n, and an index writer pool 354 that includes a corresponding number of index writers 354a-354n.

In a typical implementation, DB controller 351 can represent Microsoft's Extensible Storage Engine (ESE) which provides an API for accessing an EDB (e.g., ESENT.DLL). The ESE and its API are oftentimes referred to as Joint Engine Technology (JET) Blue and the JET API. In any case, DB controller 351 comprises the functionality by which a client can read records (i.e., email data) within EDB 215.

DB worker pool 352 is configured to launch instances of DB mailbox enumerators. For example, FIG. 3 shows that a number of DB mailbox enumerators 352a-352n have been launched where each DB mailbox enumerator is configured to employ DB controller 351 to retrieve the contents of a particular mailbox stored in EDB 215. When DB controller 351 is the ESE, each of DB mailbox enumerators 352a-352n can be configured to submit appropriate API calls to the ESE to sequentially read the contents of the corresponding mailbox stored within EDB 215. It is noted that DB worker pool 352 launches a plurality of instances of DB mailbox enumerators so that a plurality of mailboxes can be accessed in parallel thereby increasing the speed and efficiency of retrieving email data from EDB 215.

Emails are typically stored in EDB 215 with the content of their bodies in either rich text (RTF) format or HTML format. Accordingly, as each DB mailbox enumerator retrieves an email from a mailbox in EDB 215, the body of the email will typically be either RTF or HTML. Also, email attachments will typically be formatted in a non-text format (e.g., PDF, PPT, XLS, DOCX, etc.). In accordance with embodiments of the present invention, each of DB mailbox enumerators 352a-352n can include/employ functionality for converting email data from its non-text format into a text format (i.e., plain text format) to allow the email data to be stored in a full-text index. For example, each DB mailbox enumerator can include/employ a RTF parser and an HTML parser for extracting the text from the body of the emails as well as an attachment parser for extracting the text from any attachments. The content of headers, fields, and other properties of an email are typically already in text format. However, in cases where such content may not be in text format, the DB mailbox enumerators can employ appropriate tools to convert the content into text format.

Accordingly, the output of DB mailbox enumerators 352a-352n can be email data that is in text format including the body and subject of the email, the contents of the to, from, cc, bcc, or other addressing fields and/or headers, any metadata of the email such as a folder it is stored in, an importance, created date, deleted date, received date, modified date, a classification, inclusion in a conversation, size, any hidden fields, etc., the title and content of any attachments, any metadata of an attachment such as size or mime, etc. In addition to these individual email-specific items, DB mailbox enumerators 352a-352n can also be configured to retrieve information about the mailbox and any folders it may include such as a mailbox name, mailbox size, mailbox message count, folder name, folder path, folder description, folder created date, folder class, folder item count, etc.

When DB mailbox enumerators 352a-352n have retrieved an email and converted it into text (including any attachments), this email data in text format can be passed into the corresponding queues 353a-353n which are positioned between DB worker pool 352 and index writer pool 354. Index writer pool 354 can be configured to launch a number of index writers 354a-354n which are each configured to access the textual email data from a corresponding queue 353a-353n and cause the text-based email data to be stored in a corresponding full-text index 302a-302n. In some embodiments, an index writer can employ information about the mailbox (e.g., the mailbox name) to ensure that the textual email data is stored properly as will be further described below.

In some embodiments, each of index writers 354a-354n can be configured to employ appropriate APIs of a full-text search and analytics engine 302 such as Elasticsearch. As an overview, Elasticsearch allows text-based data to be quickly indexed and then accessed using a REST API (e.g., JSON over HTTP). Accordingly, in typical embodiments, index writers 354a-354n can each be configured to create appropriately formatted HTTP requests for indexing each email (including any attachments) in the corresponding index. Once indexed, the email data can be accessed using text-based queries which will greatly increase the speed and efficiency of searching the email data.

In summary, indexing component 122 can be configured to access individual mailboxes within EDB 215, convert the emails and any attachments into text format, and then submit the email data in text format for indexing in a full-text index. The use of DB worker pool 352 and index writer pool 354 allow this access, conversion, and indexing to be performed on multiple mailboxes in parallel. Indexing component 122 can also be scaled as necessary. For example, multiple CPUs can be employed to each execute an instance of DB worker pool 352 and index writer pool 354 to increase the parallel processing. Further, in some cases, DB worker pool(s) 352 can be executed on one or more separate machines from those used to execute index writer pool(s) 354 to thereby form an indexing cluster. Any of these customizations to the architecture of indexing component 122 (and recovery manager 120) can be employed to increase the number of mailboxes that can be indexed in parallel.

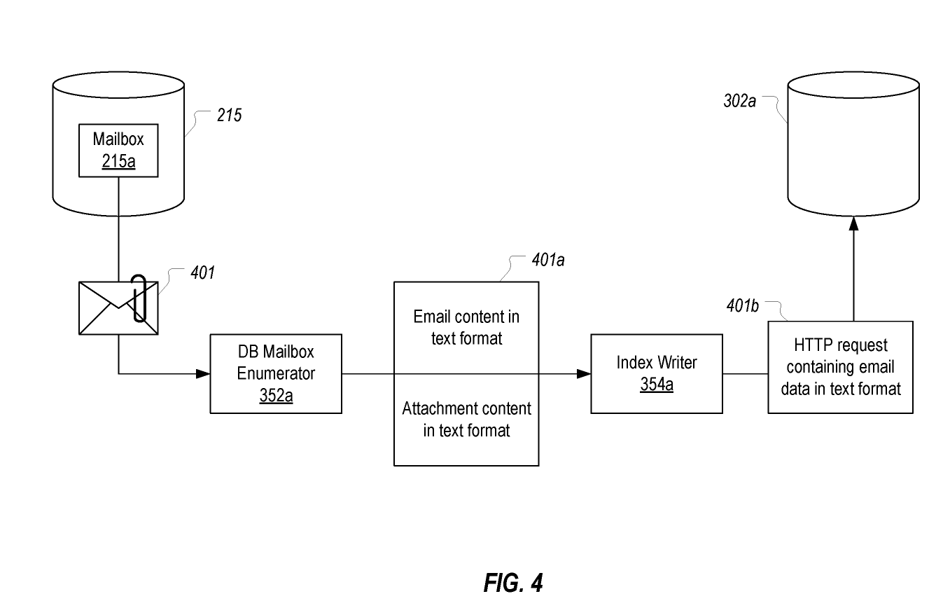

FIG. 4 illustrates a more detailed example of how indexing component 122 may index email data from a particular mailbox 215a that is stored within EDB 215. For ease of illustration, only a portion of the components depicted in FIG. 3 are included in FIG. 4. As shown, EDB 215 is assumed to include a mailbox 215a and mailbox 215a is assumed to include a number of emails such as email 401. Email 401 is also assumed to be in RTF format and to include an attachment that is in PDF format.

As described above, DB worker pool 352 can configure DB mailbox enumerator 352a to retrieve the emails from mailbox 215a (as well as the appropriate mailbox data) using the ESE API. Accordingly, FIG. 4 represents that DB mailbox enumerator 352a receives email 401 in RTF format with its accompanying attachment in PDF format. DB mailbox enumerator 352a can then convert the contents of the email and the attachment into email data 401a in text format (e.g., by using an RTF parser and a PDF parser). Email data 401a in text format can then be placed in queue 353a (not shown) to enable index writer 354a to access it.

Index writer 354a can then access email data 401a and create an appropriately formatted HTTP request 401b for indexing email data 401a. HTTP request 401b can identify an appropriate index in which email data 401a should be stored which in this case is assumed to be index 302a (i.e., index 302a corresponds to mailbox 215a). Index writer 354a can then transmit HTTP request 401b to full-text search and analytics engine 302 which will cause email data 401a to be stored in index 302a. Once stored in index 302a, email data 401a can then be searched/retrieved using text-based queries.

In FIG. 4, for simplicity, it is assumed that index writer 354a includes only the content of email 401 in HTTP request 401b. However, in many embodiments, index writer 354a would combine the content of a number of emails, and possibly the content of all the emails of mailbox 215a, into a single HTTP request, or in Elasticsearch terminology, into a “bulk” request. The present invention extends to any of these variations, i.e., embodiments where the content of one email, of multiple emails, or of all emails in a mailbox is included in a single indexing request.

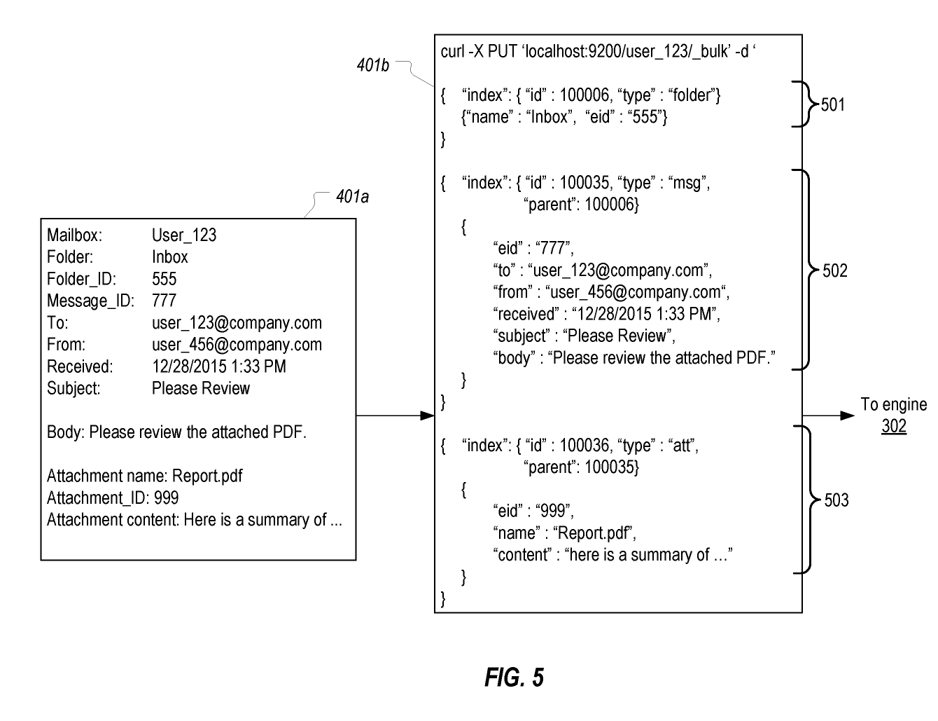

FIG. 5 illustrates a more detailed example of how index writer 354a can create HTTP request 401b from email data 401a. In this example, it will be assumed that email data 401a corresponds to an email retrieved from User_123 's inbox folder and that a corresponding full-text index has already been created for User_123 's mailbox. Email data 401a is shown as including content that is typical of an email including to, from, received, and subject fields (which are assumed to have already been in text format), a body (which is assumed to have been converted from RTF to text by DB mailbox enumerator 352a), an attachment name (which is assumed to have already been in text format), and attachment content (which is assumed to have been converted from PDF to text by DB mailbox enumerator 352a). Email data 401a is also shown as including mailbox and folder fields which identify that the email was stored in the inbox folder of User_123 's mailbox. Email data 401 is further shown as including an identifier (ID 555) of the email. This identifier is a unique identifier (e.g., the object identifier) for email 401 within EDB 215 and can therefore be used to retrieve email 401 from EDB 215. Email data 201a is further shown as including identifiers for the folder, message, and attachment (555, 777, and 999 respectively). These identifiers can represent the identifiers used to uniquely represent the records within the EDB (EDB identifiers or eids).

It is reiterated that the role of the DB mailbox enumerator is to retrieve emails from a particular mailbox in EDB 215 and to convert any of the email's non-text content into text content so that the email (or at least the relevant portions of the email) is fully represented as text. Accordingly, FIG. 5 represents that email data 401a, which is provided to index writer 354a, includes the email's content in text format along with the associated identifiers of the type of content.

Index writer 354a can process email data 401a to create an appropriately configured HTTP request 401b for storing email data 401a in the corresponding full-text index 302a. In FIG. 5, HTTP request 401b is structured in accordance with the Elasticsearch API as an example. In this example, the cUrl utility is employed to submit a Put request (−X PUT) to localhost on port 9200 where it is assumed the Elasticsearch engine is listening. Additionally, HTTP request 401b also includes the arguments “/user_123/_bulk.” The argument after the first slash (i.e., “user_123”) identifies the index into which the “documents” included in HTTP request 401b are to be stored. Also, the argument after the second slash (i.e., “_bulk”) identifies that HTTP request 401b is a bulk request (i.e., that it includes more than one document to be inserted into the index).

In Elasticsearch, a document is the basic unit of information that can be indexed and a type must be specified for any document to be indexed. In accordance with some embodiments of the present invention, the full-text index for each mailbox can be structured hierarchically. In particular, the index can be structured with a folder type, a message type, and an attachment type. The message type can include a parent parameter that allows a folder to be identified as the parent of a particular message (i.e., defining which folder the message is stored in). Similarly, the attachment type can include a parent parameter that allows a message to be identified as the parent of a particular attachment (i.e., defining which email the attachment is attached to). This hierarchical structure may be preferred in many implementations because it can optimize storage of the email data. However, in other embodiments of the present invention, it is possible that only an email type is defined which includes properties defining the folder to which the email belongs and any attachments that it includes.

HTTP request 401b, as shown in FIG. 5, represents the case where index 302a is structured to include the hierarchical arrangement of folder, message, and attachment types. Accordingly, to store email data 401a in full-text index 302a, index writer 354a can structure HTTP request 401b as a bulk request that stores a folder document (assuming that the folder document was not previously created in index 302a), a message document, and an attachment document. Each of these documents can be defined as name/value pairs (e.g., in JSON format). For example, in FIG. 5, three portions 501, 502, and 503 of HTTP request 401b are identified.

Portion 501 defines a folder document (as represented by the type/folder pair) having a name of Inbox and an eid of 555 (where eid represents the identifier used in the EDB to uniquely identify the Inbox folder of User_123 's mailbox). The id/100006 pair defines an identifier to be used within index 302a to represent this folder document. As indicated above, it is assumed that a folder document for the inbox has not previously been created in index 302a. However, if a folder document had already been created, portion 501 would not need to be included within HTTP request 401b.

Portion 502 defines a message document (as represented by the type/msg pair) that is stored in the inbox (as defined by the parent/100006 pair where 100006 is the id of the inbox folder document in index 302a). This message document is also given an id of 100035 to be used as the identifier within index 302a. The actual content of email 401 is then defined as name/value pairs. It is noted that a portion 502 only includes a subset of the possible name/value pairs. Importantly, these name/value pairs includes one for the body of the email that includes the content of the body in text format.

Portion 503 defines an attachment document (as represented by the type/att pair). This attachment document defines a parent id of 100035 (the id for the message document created for email 401) thereby associating the attachment with email 401. The attachment document also includes a number of name/value pairs, including, most notably, one for the content of the attachment that includes the content of the attachment in text format.

When HTTP request 401b is submitted, engine 302 will add these three documents (or name/value pairs) to index 302a. As a result, text-based queries can be employed to search index 302a to retrieve the content of email 401 including the content of email 401's attachment. It is again reiterated that the structure of HTTP request 401b including the name/value pairs of each document are only examples. A portion of a specific schema that can be employed for a full-text index is provided below as a non-limiting example to illustrate a number of possible name/value pairs that may be included in the different document types.

“folder” : {

```
  “_source” : {“enabled” : false },
  “_all” : {“enabled” : false},
  “properties” : {
```

```
“eid” : { “type” : “string”, “store”: true },
“name” : { “type” : “string”},
“path” : {
  “type”:“string”,
  “index”:“analyzed”,
  “store” : true,
  “fields” : {
```

```
“path_analyzer”:{
  “type” : “string”,
  “index_analyzer” : “path-analyzer”,
  “search_analyzer”: “keyword”
},
“not_analyzed”:{
  “type”:“string”,
  “index”:“not_analyzed”
}
```

```
  }
  },
“description” : { “type” : “string”},
“created”: { “type” : “date”, “format”: “date_time”},
“folderclass” : { “type” : “string”},
“item_count” : {“type” : “integer”},
“mailbox_name” : { “type” : “string”},
“mailbox_size” : { “type” : “long”},
“mailbox_msg_count” : { “type” : “integer”}
```

}
},

“msg” : {

```
  “_parent” : { “type” : “folder” },
  “_source” : {“enabled” : false },
  “_all” : {“enabled” : false},
  “properties” : {
```

“eid” : { “type” : “string”, “store”: true },
“subject”: { “type” : “string”},
“from”: { “type” : “string”},
“to”: { “type” : “string”},
“cc”: { “type” : “string”},
“bcc”: { “type” : “string”},
“created”: { “type” : “date”, “format”: “date_time” },
“received”: { “type” : “date”, “format”: “date_time”},
“deleted”: { “type” : “date”, “format”: “date_time”},
“modified”: { “type” : “date”, “format”: “date_time” },
“body” : { “type” : “string” },
“messageclass”: { “type” : “string”},
“categories” : { “type” : “string”},
“importance” : { “type” : “string”},
“conversation” : { “type” : “string”},
“message_size” : { “type” : “long”},
“hidden” : {“type”:“boolean”}

```
  }
},
“att” : {
  “_parent” : {“type”:“msg”},
  “_source” : {“enabled” : false },
  “_all” : {“enabled” : false},
  “properties” : {
```

“eid” : { “type” : “string”, “store”: true },
“name” : { “type” : “string”},
“mime” : { “type” : “string” },
“size” : {“type” : “long” },
“file” : { “type” : “string”}

}
}

DB mailbox enumerator 352a and index writer 354a can perform this process on all emails stored in mailbox 215a so that a complete full-text index 302a is created to represent mailbox 215a. With full-text index 302a created, User_123 's mailbox can be quickly and efficiently searched by accessing full-text index 302a rather than by accessing mailbox 215a in EDB 215. This same process can also be performed to create a full-text index for every mailbox contained in EDB 215. In this way, text-based queries can be performed across all the full-text indexes to identify relevant email data without needing to qeury EDB 215.

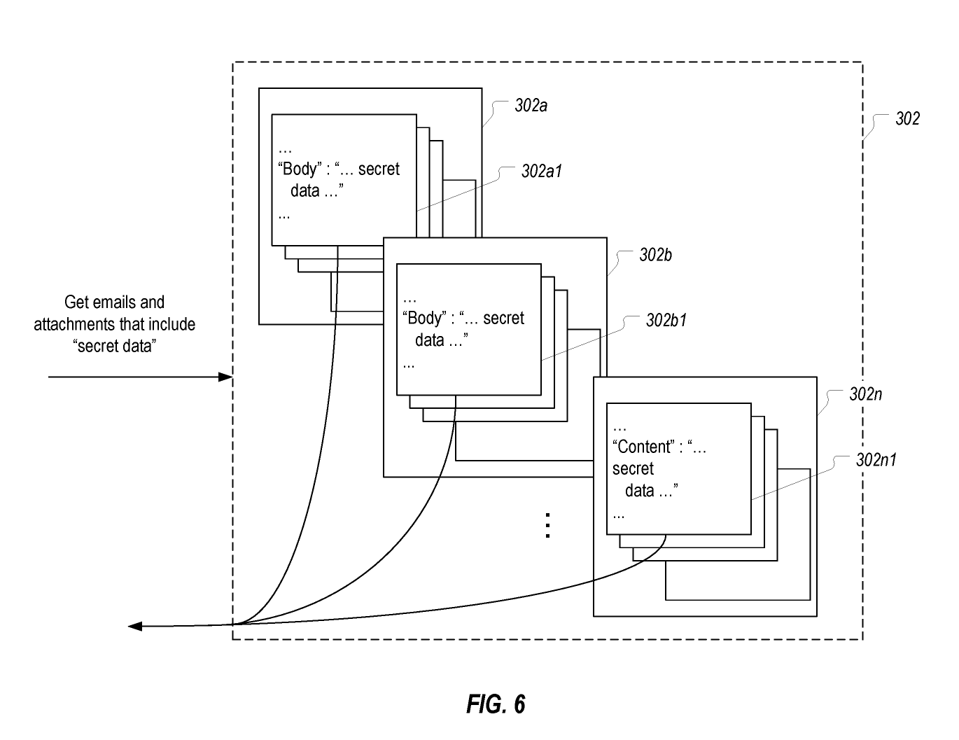

FIG. 6 provides one example of the type of queries that can be facilitated by creating full-text indexes of each mailbox in EDB 215. Recovery console 123 could provide an interface through which such queries can be submitted. As shown, full-text indexes 302a-302n have been created for each mailbox stored in EDB 215 and each of these full-text indexes includes “documents” representing the folders, emails, and attachments of the corresponding mailbox. A user has submitted a query of “get emails and attachments that include ‘secret data’” to engine 302. Because indexes 302a-302n are full-text indexes, this query can be quickly and efficiently processed by identifying which “msg” or “att” documents include a “body” or “content” name with a corresponding value that includes “secret data.” In this case, it is assumed that documents 302a1 and 302b1, which represent emails, and document 302n1, which represents an attachment, match the query and would therefore be returned.

Other examples of the types of queries that can be facilitated by creating full-text indexes for each mailbox include: “get attachments of emails sent with high importance;” “get folders in a specific mailbox with a message count exceeding 1000;” and “get messages with a red category and an attachment that contains “credit.” As can be seen, by converting emails from their native format into the textual name/value pairs (e.g., JSON name/value pairs), complex queries can be immediately performed based on any possible combination of values. In this way, the present invention can greatly expedite the process of accessing archived email data to search for relevant content.

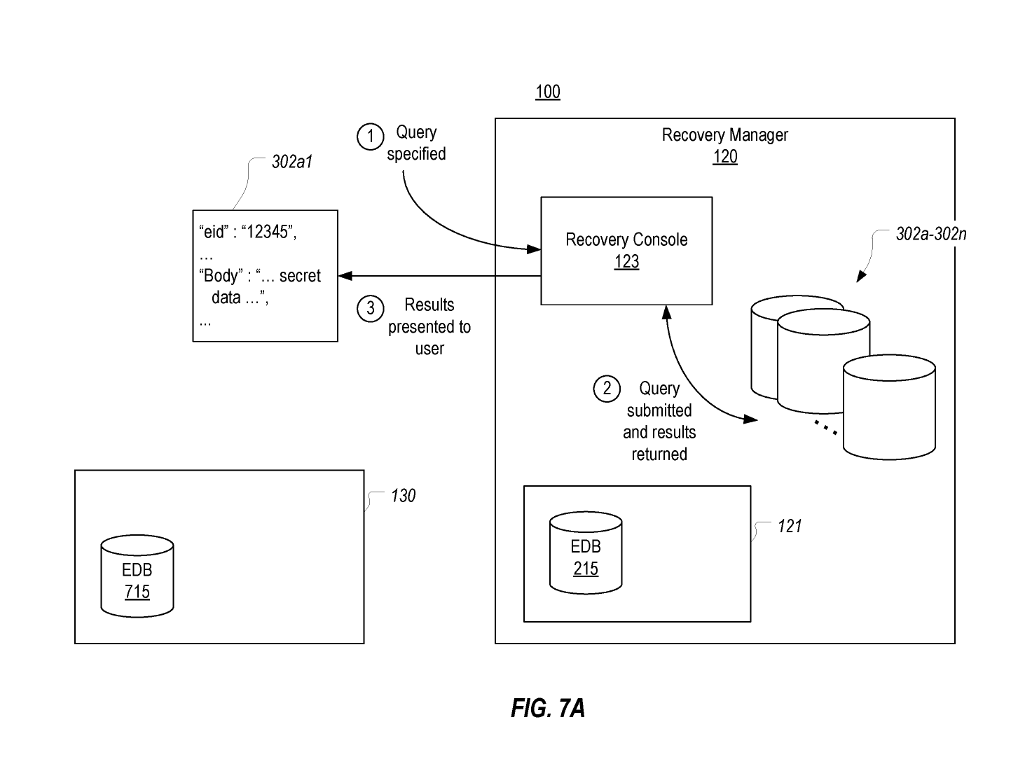

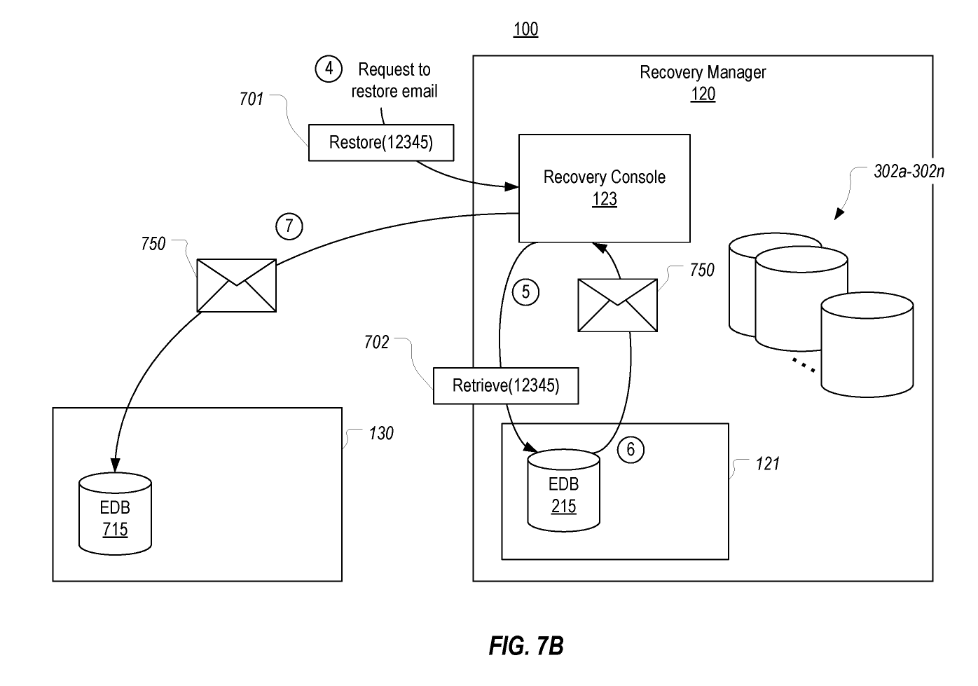

FIGS. 7A and 7B generally illustrate how recovery manager 120 can be employed to efficiently restore a single email to production Exchange environment 130. In these figures, it will be assumed that production Exchange environment 130 includes an EDB 715 which is the live version of the EDB employed to provide email services.

In a first step, a user specifies a query via recovery console 123 to search one or more of full-text indexes 302a-302n. For example, this query could be “get emails that include ‘secret data’ in their body. To process such queries, recovery console 123 could be configured to create appropriately formatted requests such as HTTP requests in an Elasticsearch implementation.

In a second step, recovery console 123 submits the appropriately formatted query and receives corresponding results. For purposes of the present example, it will be assumed that these results include a msg document 302a1 and that this msg document includes an eid of 12345. In a third step, recover console 123 can present the results to the user. For example, recovery console 123 can parse msg document 302a1 to display the contents of the document (e.g., to present the contents to the user in a typical email format).

After reviewing the results, the user may elect to restore one or more emails represented in the results. For example, in a fourth step, the user submits a request 701 to restore the email having an eid of 12345. Upon receiving request 701, in a fifth step, recovery console 123 can perform appropriate API calls 702 (e.g., via ESE) to access the specified email from EDB 215 within emulated Exchange environment 121. Because the eid of the email was retrieved from full-text index 302a, the specific email can be retrieved from EDB 215 without requiring any searching of EDB 215. In a sixth step, the corresponding email 750 is returned to recovery console 123. Finally, in a seventh step, recovery console 123 can perform appropriate API calls (e.g., via ESE) to add email 750 to the appropriate mailbox within EDB 715 in production Exchange environment 130.

As can be seen, this process facilitates the identification and restoration of emails at a granular level. By creating full-text indexes of each mailbox in the restored EDB, the content of these mailboxes can be quickly searched using text-based queries. Then, once any relevant email is identified, the individual email can be quickly obtained from the EDB in the emulated environment and restored to the production environment without needing to restore the entire EDB to the production environment. The user can therefore restore emails with minimal impact on the production environment.

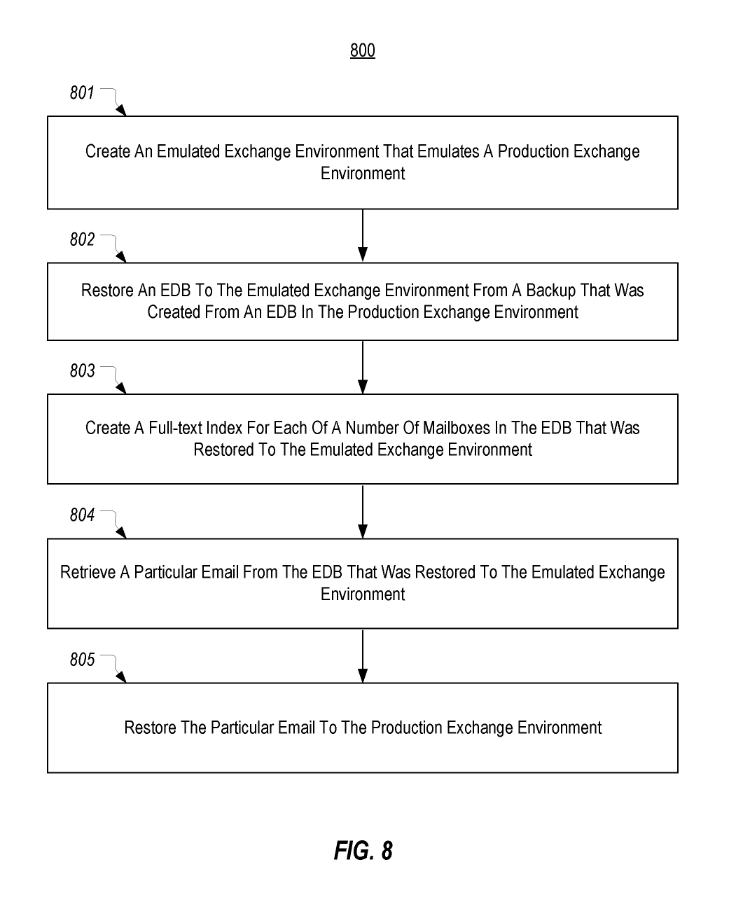

FIG. 8 illustrates a flowchart of an example method 800 for restoring emails. Method 800 can be implemented in computing environment 100.

Method 800 includes an act 801 of creating an emulated Exchange environment that emulates a production Exchange environment. For example, emulated Exchange environment 121 can be created in recovery manager 120 which emulates production Exchange environment 130.

Method 800 includes an act 802 of restoring an EDB to the emulated Exchange environment from a backup that was created from an EDB in the production Exchange environment. For example, backup 115 can be restored into emulated Exchange environment 121.

Method 800 includes an act 803 of creating a full-text index for each of a number of mailboxes in the EDB that was restored to the emulated Exchange environment. For example, indexing component 122 can create full-text indexes 302a-302n from mailboxes contained within EDB 215.

Method 800 includes an act 804 of retrieving a particular email from the EDB that was restored to the emulated Exchange environment. For example, recovery console 123 can retrieve email 750 from EDB 215 within emulated Exchange environment 121.

Method 800 includes an act 805 of restoring the particular email to the production Exchange environment. For example, recovery console 123 can restore email 750 to EDB 715 within production Exchange environment 130.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for restoring emails comprising:
creating an emulated Exchange environment that emulates a production Exchange environment;
restoring an EDB to the emulated Exchange environment from a backup that was created from an EDB in the production Exchange environment;
creating a full-text index for each of a number of mailboxes in the EDB that was restored to the emulated Exchange environment;
retrieving a particular email from the EDB that was restored to the emulated Exchange environment; and
restoring the particular email to the production Exchange environment.

2. The method of claim 1, further comprising:
querying at least one of the full-text indexes to produce a result set; and
obtaining an identifier of the particular email from the result set, wherein the particular email is retrieved using the identifier.

3. The method of claim 1, wherein creating a full-text index for each of a number of mailboxes in the EDB that was restored to the emulated Exchange environment comprises:
for each of the number of mailboxes, accessing the EDB to retrieve each email in the mailbox, at least some of the emails including content that is not formatted as plain text;
for each accessed email:
converting content of the email that is not formatted as plain text into plain text;
creating an indexing request that identifies a full-text index corresponding to the mailbox and that includes the content of the email in plain text format; and
submitting the indexing request to cause the content of the email to be stored in the full-text index.

4. The method of claim 3, wherein the content that is not formatted as plain text comprises a body of the email.

5. The method of claim 3, wherein the content that is not formatted as plain text comprises an attachment of the email.

6. The method of claim 3, wherein the content of the email is included in the indexing request as name/value pairs.

7. The method of claim 6, wherein the name/value pairs include an identifier of the email that is employed within the EDB to uniquely identify the email within the EDB.

8. The method of claim 7, wherein the particular email is retrieved from the EDB using the identifier.

9. The method of claim 6, wherein, for any email that includes an attachment, the indexing request is structured to cause the content of the attachment to be stored separately from but hierarchically associated with the content of the email.

10. A recovery manager for restoring emails comprising:
an emulated Exchange environment that emulates a production Exchange environment and that is configured to interface with a data protection server to cause a backup of the production Exchange environment to be restored into the emulated Exchange environment, the backup including an EDB;
an indexing component configured to generate full-text indexes for mailboxes contained within the EDB once the EDB is restored into the emulated Exchange environment; and
a recovery console configured to query the full-text indexes to identify particular emails, to obtain the particular emails from the EDB in the emulated Exchange environment, and to restore the particular emails obtained from the EDB in the emulated Exchange environment into an EDB in the production Exchange environment.

11. The recovery manager of claim 10 wherein the recovery console obtains the particular emails by employing identifiers of the particular emails that were obtained from the full-text indexes.

12. The recovery manager of claim 10, wherein generating full-text indexes comprises converting non-plain-text portions of emails or attachments into plain text.

13. The recovery manager of claim 10, wherein generating full-text indexes comprises submitting indexing requests that include content of emails in name/value pairs.

14. The recovery manager of claim 13, wherein the name/value pairs include a pair for a body of an email with the content of the body in plain text format and a pair for content of an attachment with the content of the attachment in plain text format.

15. The recovery manager of claim 14, wherein the name/value pairs include a pair for an identifier of an email that is employed within the EDB to uniquely identify the email.

16. The recovery manager of claim 15, wherein querying the full-text indexes to identify particular emails comprises retrieving the identifiers of the particular emails from corresponding name/value pairs, and wherein obtaining the particular emails from the EDB in the emulated Exchange environment comprises specifying the identifiers of the particular emails in one or more calls to an API for accessing the EDB.

17. The recovery manager of claim 10, wherein the indexing component comprises:
a database worker pool that is configured to launch a number of database mailbox enumerators, each database mailbox enumerator being configured to employ a database controller to access a particular mailbox within the EDB to retrieve emails from the particular mailbox, each database mailbox enumerator being further configured to convert each email into email data that is in plain text format; and
an index writer pool that is configured to launch a number of index writers, each index writer being configured to receive the email data from a corresponding database mailbox enumerator and to generate one or more indexing requests for storing the email data in a corresponding full-text index.

18. A method for enabling individual emails to be restored, the method comprising:
creating an emulated Exchange environment that emulates a production Exchange environment;
restoring an EDB to the emulated Exchange environment from a backup that was created from an EDB in the production Exchange environment;
retrieving, from each of a plurality of mailboxes stored in the EDB restored to the emulated Exchange environment, each email stored in the mailbox;
converting content of a body or of an attachment of at least some of the emails into a plain text format;
for each mailbox, generating one or more indexing requests for storing the emails of the mailbox in a full-text index, the one or more indexing requests including content of the emails represented as name/value pairs where the value of each name/value pair is in plain text format; and
submitting the one or more indexing requests for each mailbox to thereby cause a full-text index to be created for each mailbox.

19. The method of claim 18, further comprising:
receiving a request to query at least one full-text index; and
returning results of the query, the results including an identifier employed within the EDB to uniquely identify a particular email.

20. The method of claim 19, further comprising:
employing the identifier to retrieve the particular email from the EDB in the emulated Exchange environment; and
restoring the particular email to an EDB in the production Exchange environment.
